(19) United States
(12) Patent Application Publication
(10) Pub. No.: US 2013/0260024 A1
(43) Pub. Date: Oct. 3, 2013

(54) METHOD FOR PRODUCING LITHIUM-BASED LAYERS BY CVD

(71) Applicants: Annealsys, Montpellier (FR); Commissariat A L'Energie Atomique Et Aux Energie Alternatives, Paris (FR)

(72) Inventors: Lucie JODIN, Nancy (FR); Philipp ACHATZ, Grenoble (FR); Jean-Manuel DECAMS, Montpellier (FR); Jean-Luc DESCHANVRES, Meylan (FR); Maria del Carmen JIMENEZ AREVALO, Grenoble (FR); Sylvain POULET, Saint Victor De Cessieu (FR)

(73) Assignees: Annealsys, Montpellier (FR); Commissariat A L'Energie Atomique Et Aux Energie Alternatives, Paris (FR)

(21) Appl. No.: 13/894,612

(22) Filed: May 15, 2013

Related U.S. Application Data
(63) Continuation of application No. PCT/FR2011/052899, filed on Dec. 8, 2011.

(30) Foreign Application Priority Data
Dec. 9, 2010 (FR) 10.60280

(51) Int. Cl. H01M 4/04

(52) U.S. Cl. CPC H01M 4/0428
USPC 427/126.1

(57) ABSTRACT

A method for forming by CVD a lithium-based layer, according to which the lithium precursor is in liquid form in a mixture containing a solvent and a Lewis base.

### FIELD OF THE INVENTION

The present invention relates to the manufacturing of thin-film batteries, with a high power density.

The targeted applications especially concern chip cards and smart tags enabling to recurrently measure parameters by means of miniaturized implants. Another important application relates to the power supply of internal clocks and of microsystems. These applications impose for all the layers necessary to the battery operation to be manufactured with techniques compatible with industrial methods of microelectronics.

In practice, film batteries are deposited on 3D substrates to increase the active surface area without modifying the component size. In this context, it is necessary to use conformal deposition techniques enabling to precisely control the chemical composition of the material since the active layers are highly sensitive to a modification of their composition.

More specifically, the present invention relates to a CVD method (“Chemical Vapor Deposition”) for manufacturing a layer containing lithium, such as LiPON (“Lithium Phosphorous OxyNitride”), LiSiPON (“Nitrogen-incorporated Lithium SilicoPhosphate”), or (Li,La)TiO₃ (Lithium lanthanum titanate), involving precursors contained in a liquid mixture comprising a solvent and a Lewis base.

### BACKGROUND

“All-solid” microbatteries, in the form of thin films, have been widely described in prior art. The operating principle relies on the insertion and the desinsertion (or intercalation/deintercalation) of an alkaline metal ion or of a proton in the positive electrode. The main systems use, as an ion species, the lithium ion or Li⁺. All the microbattery components (current collectors, positive and negative electrodes, electrolyte, encapsulation) are in the form of thin layers obtained by PVD (“Physical Vapor Deposition”) or CVD.

The total thickness of the stack is on the order of 15 μm.

Different materials may be used:
the current collectors are metallic and may for example contain Pt, Cr, Au, Ti, W, Mo.
the positive electrode may especially be formed of LiCoO₂, LiNiO₂, LiMn₂O₄, CuS, CuS₂, WO_{y}S_{z}, TiO_{y}S_{z}, V₂O₅. According to the selected materials, a thermal anneal may be necessary to increase the crystallization of the films and their insertion properties. Such is for example the case for lithium oxides. However, certain amorphous materials do not require such a processing, while allowing a high insertion of lithium ions.
the electrolyte must be a good ion conductor and electronic insulator. It generally is a vitreous material containing phosphorus oxide, boron, lithium oxides, or lithium salts. The electrolytes with the best performance contain phosphate, such as LiPON (“Lithium Phosphorous OxyNitride”) or LiSiPON (“Nitrogen-incorporated Lithium SilicoPhosphate”). Their composition will determine the electric properties, and especially the nitrogen concentration, which enables to increase the ion conductivity.
the negative electrode may be metallic lithium deposited by thermal evaporation, a metal alloy containing lithium, or an insertion compound (SiTON, SnNₓ, InNₓ, SnO₂ . . . ). It should be noted that there also exist microbatteries with no anode (called “Li free”). In this case, a metal layer blocking the lithium is directly deposited on the electrolyte. The lithium then deposits on this layer.
the encapsulation aims at protecting the active stack from the outer environment and specifically from humidity. Different strategies may be used: encapsulation from thin layers, co-laminated encapsulation, or cover encapsulation.

The research made in this field aims at increasing the power density of microbatteries, and this, in different possible ways:
by increasing the performance of the materials; and/or
by increasing the thicknesses; and/or
by performing the depositions on 3D textured structures, which enables to increase the active surface area of the battery.

This third way is that selected for the present invention, which more specifically focuses on electrolyte deposition.

It is admitted that the PVD technique (physical vapor deposition), a standard method for depositing materials for microbatteries, is not adapted to depositions on 3D structures. It is thus necessary to use alternative techniques such as CVD, possibly plasma-enhanced (PE-CVD).

Thus, document US 2005/0016458 describes a device enabling to form a thin layer LiPON-based electrolyte. It implements the PE-CVD technique, and uses solid lithium precursors and solid or liquid phosphorus precursors, which are heated in bubbling systems in order to be evaporated. The nitrogen is incorporated into the layer by means of a plasma present in the deposition chamber.

The provided method however raises the following issues:
the poor properties of PE-CVD for 3D deposition;
the evaporation of the precursors by bubbling:
   difficult control of the gas flow rates sent into the deposition chamber, which generates problems of reproducibility in terms of thickness and/or of layer composition;
   heating of all the “precursor” source strongly limiting the selection of organometallic precursors likely to be used: most lithium-based organometallic materials tend to form oligomers which are difficult to evaporate, and even to decompose when the heating is extended, which results in a poor evaporation efficiency;
   for precursors having a low vapor pressure, such as lithium-based organometallic complexes, it is extremely difficult or even impossible to generate vapor rates sufficiently high to obtain films with high growth rates;
difficult control of the nitrogen rate due to the plasma incorporation mode.

As a summary, such a vaporization process does not enable to control the quantity of involved precursors. Further, it has a low efficiency since it generates little vapor for a significant quantity of initial matter.

There thus is an obvious need to develop new methods for forming thin layers containing lithium which do not have the above-mentioned disadvantages.

### DISCUSSION OF THE INVENTION

In practice, the present invention thus aims at a method for forming a lithium-based electrolyte for thin-film batteries on a 3D substrate. This electrolyte may for example be LiPON, which contains lithium (Li), phosphorus (P), oxygen (O), and nitrogen (N).

As already mentioned, in such a context, the adapted deposition technique is CVD. As a reminder, CVD is a method for forming a thin layer on a surface when, by chemical reaction, certain elements of a gaseous mixture placed in specific pressure and temperature conditions pass from the vapor state to the solid state by depositing on the material forming the surface. The CVD may be plasma-enhanced (PE-CVD).

The main difficulty then is due to lithium (Li) since there exist no lithium compounds in gas or liquid form at ambient temperature, compatibles with CVD.

The only option available up to now is to use solid precursors, as described in document US 2005/0016458.

The present invention provides a particularly appropriate alternative solution which comprises going through an intermediate liquid phase. It is indeed easier to vaporize a liquid than a solid. More specifically, the present invention relates to a method for forming by CVD a lithium-based layer, according to which the lithium precursor is in liquid form in a mixture containing a Lewis base.

According to a preferred embodiment, the method according to the invention thus uses a liquid mixture comprising at least a lithium precursor, a Lewis base, and a solvent.

In other words, the liquid medium comprises at least three distinct entities, that is, the lithium precursor, a solvent, and a Lewis base. It should be noted that in certain cases, a same molecule may perform two of these functions (for example, solvent and Lewis base or lithium precursor and Lewis base) but that the invention provides the intentional addition of a Lewis base, advantageously as defined hereafter, in addition to the precursor and to the solvent normally used.

According to the principle of CVD, this liquid mixture is then sprayed in the form of an aerosol, and then evaporated.

Preferably, the layer is made of a material selected from the following group:
LiPON;
LiSiPON; and
(Li,La)TiO₃.

As mentioned, lithium precursors are poorly soluble or unstable in solution. Indeed, lithium (Li) is a chemical element belonging to the first column of the periodic table of elements. Such elements, called alkaline, are generally strongly electropositive, thus mainly resulting in the forming of complexes with strong ionicities.

In practice, the lithium precursors used in CVD, that is, lithium-based organometallic compounds, appear in the form of solid oligomers. Now, such solid oligomers generally have low vapor pressures and poor properties of solubility in solvents conventionally used for the dissolving of organometallic precursors (called “usual”).

The solution provided in the context of the present invention thus is to use a solvent and a Lewis base for dissolving the lithium precursor. By entering the coordination sphere close to the metal center, the Lewis base breaks the polymer structure of the oligomer, thus promoting the forming and the stabilization of dimer, or even monomer structures.

The chemical compounds thus formed, called “adducts”, most often have higher vapor pressures, an increased solubility in conventional aliphatic and/or aromatic organic solvents, as well as an increased thermal stability of gas-phase precursors (during the phase of vapor transport between the evaporation and the deposition chamber) but also an increased chemical stability in liquid phase (during the phase of precursor storage in the source reservoirs).

Further, in the specific case where the Lewis base is an amine, a potential nitrogen source enabling to dope the layer to be synthesized is introduced into the coordination sphere close to the metal element, and this, in a single step.

Thus, and advantageously, the Lewis base, present in the liquid mixture, further containing the lithium precursor and the solvent, is an amine, and more advantageously still:
TMEDA (N,N,N′,N′-tetramethylethylenediamine); or
TMPDA (N,N,2,2-tetramethyl-1,3-propanediamine).

More specifically, the amine Lewis base may be primary (R—NH₂), secondary (R₂—NH), or tertiary (NR₃), with R═CH₃, C₂H₅, C₃H₇, C₄H₉, or a combination of these groups in the case of secondary and/or tertiary amines.

The amine Lewis base may be monodentate, as previously mentioned, or more advantageously bidentate (diamine) of type R₂N—(CH₂)ₓ—NR₂ with x=1, 2, 3 or 4 and R═CH₃, C₂H₅, C₃H₇, C₄H₉ or a combination of these groups.

Finally, the Lewis base may be an oxygenated compound of (R—O—R) ether type, with R═CH₃, C₂H₅, C₃H₇, C₄H₉ or a combination of these groups.

Again, the oxygenated Lewis base may be monodentate, as previously mentioned (R—O—R), or more advantageously bidentate (Glyme x) of type R—O—(CH₂)ₓ—O—R with x=1, 2, 3, or 4 and R═CH₃, C₂H₅, C₃H₇, C₄H₉ or a combination of these groups.

As a variation, the Lewis base may be acetylacetone or benzylic alcohol.

A mixture of Lewis bases may of course be used.

As already mentioned, the use of an adequately selected Lewis base in association with the precursor will provide:
a chemical stabilization of the precursor in solution in the source reservoir,
an increase of the solubility thereof in conventional aliphatic and/or aromatic organic solvents,
a stabilization of the molecular structure of the precursor during the transport phase in the form of gas between the evaporator and the deposition chamber of the CVD reactor.

Preferably, the lithium precursor is a omanometallic precursor, advantageously an alkoxide, such as for example lithium tert-butoxide (LiO^{t}Bu), or a β-diketonate, such as lithium acetylacetonate (LiAcac) and/or lithium 2,2,6,6-tetramethyl-3-5-heptanedionate (LiTMHD), or an amide such as lithium Bis-trimethylsilylamidure (LiHMDS). It may of course be a mixture of lithium precursors.

The placing in liquid solution of the lithium precursor, in the presence of a Lewis base, is advantageously achieved by means of an aliphatic organic solvent of empirical formula CₓH₂ₓ₊₂ with x=3, 4 , 5, 6, 7, 8, or 9, or a non-oxygenated aromatic solvent such as benzene, toluene, xylene, mesitylene . . . , or an oxygenated organic solvent of alcohol type, such as butanol or isopropanol. Monoglyme also is a possible solvent. It may be a mixture of solvents.

Conversely to prior art where the lithium precursor was provided in solid form, the present invention provides vaporizing a lithium precursor present in liquid form. Of course, if the lithium precursor is not liquid, it may have a solid initial form. Its placing in solution by means of at least one solvent and one Lewis base then forms an intermediate step before its vaporizing.

In the liquid mixture, the molar concentration of the Lewis base generally is from 1 to 20 times greater than that of the lithium precursor. The Li concentration may advantageously range between 0.01 M and 1 M.

As already mentioned, the layer, especially the electrolyte, may contain elements other than lithium (Li), in particular phosphorus (P), nitrogen (N), oxygen (0), silicon (Si), titanium (Ti), or lanthanum (La). These elements may be introduced by means of the lithium precursor, or possibly via other precursors.

In a preferred embodiment, these other elements, especially phosphorus and/or nitrogen, are also introduced in liquid form. These advantageously are organometallic precursors in solution or in the form of pure liquids. In this case, the liquid mixture then contains, in addition to the lithium precursor, the Lewis base and the solvent, at least another organometallic precursor.

For phosphorus, phosphate-based solutions, such as triphenyl phosphate (TPPa) or trimethyl phosphate (TMPa), as well as phosphite-based solutions, for example, triphenyl phosphite (TPPi) or trimethyl phosphite (TMPi), may be used. The concentration of the solutions advantageously ranges between 0.01 M and 1 M.

The Ti precursor may be an alkoxyde or β-diketonate or oxo-β-diketonate (for example, TiO(Acac)₂) ou alcoxo-β-diketonate (for example Ti(OR)₂(TMHD)₂). The La precursor may be a complexed or not β-diketonate (for example, La(TMHD)₃) or its adduct (for example, La(TMHD)₃tetraglyme).

The different precursors may be prepared or introduced into different solutions or mixtures, in particular two, for example, one containing Li+N and the other containing P. As a variation, all precursors are in the same mixture (for example, Li+P+N), which thereby also contains the Lewis base and the solvent. As already mentioned, the nitrogen source may be formed by the Lewis base.

Conventionally, the method according to the invention is performed in a CVD-type deposition reactor. It may be carried out at low pressure as well as at the atmospheric pressure.

At the atmospheric pressure, the method comprises the steps of:
introduction of the precursors: spraying in the form of an aerosol. The aerosol may be generated either by a piezoelectric ceramic, or by a system of spraying nozzle type, or via automobile-type liquid injectors;
transfer of the aerosol to the deposition chamber by a duct having a carrier gas injected therein (Ar, O₂, N₂, air);
evaporation of the precursors close to the surface of the heated substrate;
reaction at the surface of the heated substrate (possibility of injecting reactive gases into the deposition chamber). The substrate may be heated between 200 and 700° C.

At low pressure, the method comprises the steps of:
introduction of the precursors: spraying via automobile-type liquid injectors, followed by an evaporation in an evaporator;
transfer of the gas mixture to the deposition chamber through a heated duct;
reaction at the surface of the heated substrate. Possibility of injecting reactive gases into the deposition chamber: O₂, N₂O, H₂, NH₃ . . . The pressure in the chamber is fixed. It ranges between 0.1 mbar and 500 mbar. The substrate temperature ranges between 200 and 800° C., advantageously between 300 and 500° C.

In both cases, the precursor flow rates are carefully controlled. The deposition rates may exceed 750 nm/h.

As already mentioned, especially in the preferred application relative to electrolytes for microbatteries, the method according to the invention advantageously enables to form layers on 3D textured structures.

### BRIEF DESCRIPTION OF THE DRAWINGS

The way in which the invention may be implemented and the resulting advantages will better appear from the following non-limiting embodiments, in relation with the accompanying drawings, among which:

FIG. 1 illustrates the spectroscopy impedance measurement enabling to calculate the ion conductivity of a deposition performed at the atmospheric pressure, by means of the method according to the invention.

FIG. 2 illustrates an SEM (scanning electronic microscopy) image of a deposition performed on a 3D substrate at the atmospheric pressure, by means of the method according to the invention.

FIG. 3 illustrates the spectroscopy impedance measurement enabling to calculate the ion conductivity of a deposition performed at low pressure, by means of the method according to the invention.

FIG. 4 illustrates an SEM (scanning electronic microscopy) image of a deposition performed on a 3D substrate at low pressure, by means of the method according to the invention.

### EMBODIMENTS OF THE INVENTION

### I/Preparation of a Lipon Layer

I-1/Embodiment at the Atmospheric Pressure:

A mixture of LiAcac or LiTMHD and TPPa is used at concentrations ranging between 0.03 M and 0.12 M. The solvent used is butanol or toluene by adding, as a Lewis base, acetylacetone or benzylic alcohol or TMEDA, or a mixture thereof (with a molar concentration ranging between 1 and 20 times that of the lithium precursor).

The deposition rates vary between 50 and 300 nm/h, with temperatures of the substrate carrier ranging between 400 and 550° C.

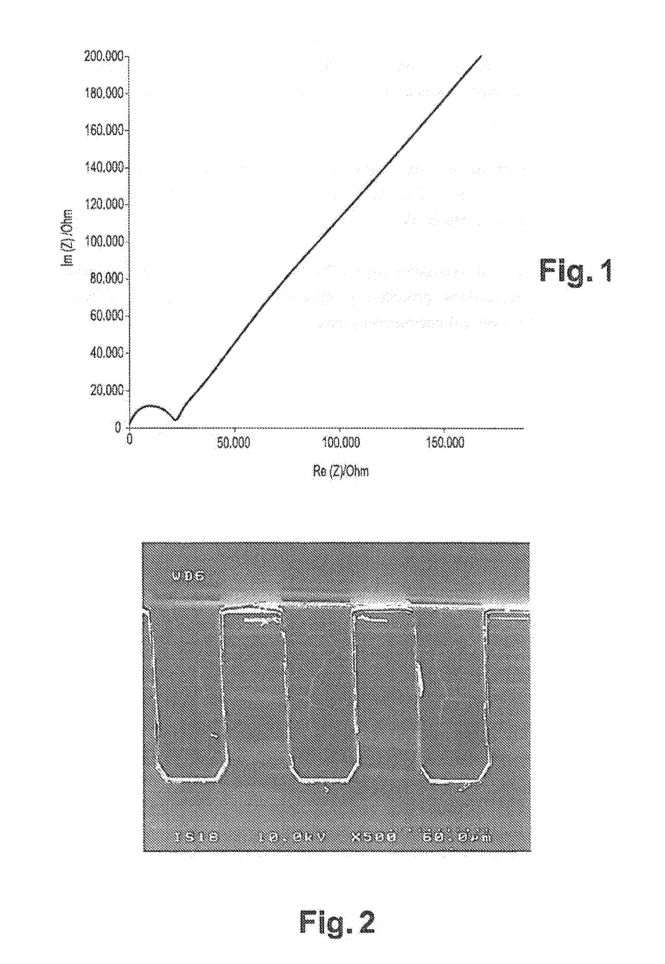

The curve of FIG. 1 enables to calculate the ion conductivity of this material: 2.10⁻⁸ S/cm.

The conformality of the deposition is greater than 70% for high shape factors (1:5) (FIG. 2).

The composition measured by XPS is Li_{2.54}PO_{3.97}N_{0.19}. The variation of the precursor concentrations varies ratios x, y, and z of the LiPON layer (LiₓPO_{y}N_{z}).

I-2/Low Pressure Embodiment:

The mixture of precursors used in this case is LiO^{t}Bu and TMEDA and TPPa. The concentration of the Li precursor solution is 0.1 M and that of phosphorus is 0.03 M. The TMEDA (Lewis base) concentration is approximately 10 times greater than that of LiO^{t}Bu. The temperature of the substrate carrier ranges between 420 and 480° C., the oxygen proportion varies from 25% to 60%. The working pressure ranges between 10 and 20 mbar.

The deposition rates range between 220 and 980 nm/h.

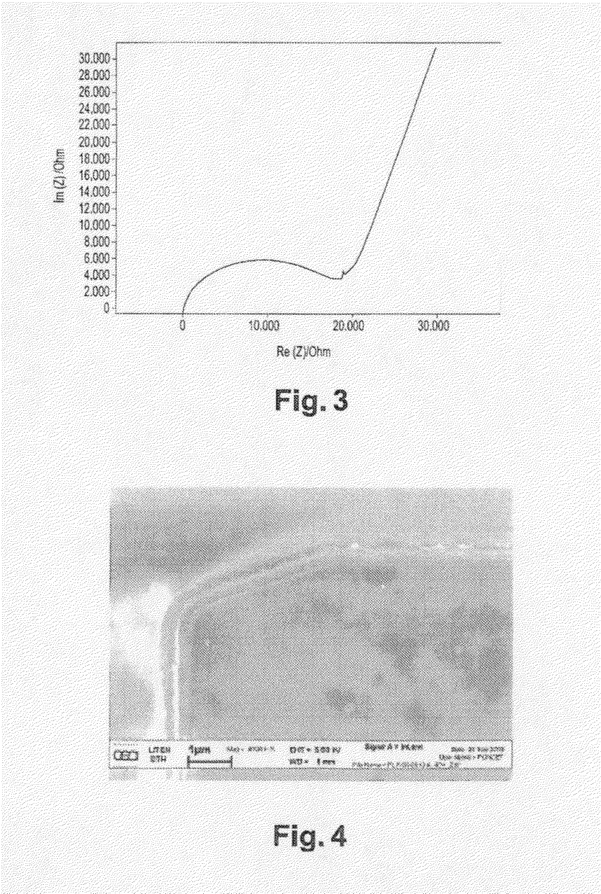

The electric properties show an ion conductivity of 2.10⁻⁹ S/cm and an electronic conductivity <7.10⁻¹⁴ S/cm (FIG. 3).

The conformality of the deposition on significant shape factors (1:5) is 56% (FIG. 4).

XPS and EDX analyses show the forming of a LiₓPO_{y}N_{z} layer.

### II/Other Materials

II-1/LiSiPON at Low Pressure:

A mixture formed of:
Bis-trimethylsilylamide Li(hmds),
TMEDA, and
TPPa
   is used at concentrations ranging between 0.03 M and 0.1 M.

The temperature of the substrate carrier ranges between 400 and 600° C., the oxygen proportion varies from 25 to 70° C. The work pressure ranges between 10 and 25 mbar.

The deposition rates range between 100 and 400 nm/h.

II-2/(Li,La)TiO₃ at the Atmospheric Pressure

A mixture of LiAcac or LiTMHD, and of Ti precursor such as alkoxyde or β-diketonate or oxo-β-diketonate (for example, TiO(Acac)₂) or alcoxo-β-diketonate (for example, Ti(OR)₂(TMHD)₂), and of La precursor such as β-diketonate, complexed or not (for example, La(TMHD)₃) or its adduct (for example La(TMHD)₃tetraglyme), is used at concentrations ranging between 0.01 M and 0.1 M. The solvent used is butanol or toluene by adding acetylacetone or benzylic alcohol or TMEDA, or a mixture thereof (with a molar concentration ranging between 1 and 20 times that of the lithium precursor).

The deposition rates vary between 50 and 500 nm/h, with temperatures of the substrate carrier ranging between 400 and 650° C.

II-3/(Li,La)TiO₃ at Low Pressure:

A mixture of LiTMHD and of Ti(OiPr)₂(TMHD)₇ and La(TMHD)₃ is used at concentrations ranging between 0.01 M and 0.1 M. The solvent used is monoglyme by adding TMEDA (with a molar concentration ranging between 1 and 20 times that of the lithium precursor).

The deposition rates vary between 50 and 500 nm/h, with temperatures of the substrate carrier ranging between 400 and 800° C., preferably between 500 and 650° C.

1. A method for forming by CVD a lithium-based layer using a liquid mixture comprising adducts formed by the placing in solution of a lithium precursor, in the presence of a Lewis base and a solvent, the three entities being distinct.

2. The method for forming by CVD a lithium-based layer of claim 1, wherein the liquid mixture is sprayed in the form of an aerosol, and then evaporated.

3. The method for forming by CVD a lithium-based layer of claim 1, wherein the layer is made of LiPON, LiSiPON, or (Li,La)TiO₃.

4. The method for forming by CVD a lithium-based layer of claim 1, wherein the Lewis base is an amine, advantageously of TMEDA or TMPDA type.

5. The method for forming by CVD a lithium-based layer of claim 1, wherein the lithium precursor is an organometallic precursor, advantageously an alkoxyde, a β-diketonate or an amide.

6. The method for forming by CVD a lithium-based layer of claim 1, wherein the solvent is a non-oxygenated aliphatic or aromatic organic solvent such as toluene or octane, or an alcohol-type oxygenated organic solvent, such as butanol or isopropanol.

7. The method for forming by CVD a lithium-based layer of claim 3, wherein the phosphorus precursor and/or the nitrogen precursor also appears in liquid form or in the form of a solution.

8. The method for forming by CVD a lithium-based layer of claim 7, wherein the phosphorus precursor and/or the nitrogen precursor is added to the liquid mixture containing the lithium precursor.

9. The method for forming by CVD a lithium-based layer of claim 1, wherein the layer is formed on a 3D textured structure.

10. The method for forming by CVD a lithium-based layer of claim 1, wherein the layer forms the electrolyte of a microbattery.
